(19) United States
(12) Patent Application Publication
(10) Pub. No.: US 2011/0093337 A1
(43) Pub. Date: Apr. 21, 2011

(54) METHODS AND SYSTEM FOR PROVIDING VIEWING RECOMMENDATIONS

(76) Inventors: Yoram Granit, Hod-HaSharon (IL); Yaniv David Solnik, Tel-Aviv (IL); Rodolfo Hecht Lucari, Milano (IT)

(21) Appl. No.: 13/000,027

(22) PCT Filed: Jun. 23, 2009
(86) PCT No.: PCT/IL09/00619

§ 371 Date: Dec. 20, 2010

Related U.S. Application Data
(60) Provisional application No. 61/129,446, filed on Jun. 26, 2008.
(60) Provisional application No. 61/129,447, filed on Jun. 26, 2008.

(51) Int. Cl. G06Q 30/00

(52) U.S. Cl. 705/14.53; 705/14.49; 705/14.66

(57) ABSTRACT

A method for promoting one or more media content items according to viewing habits at a client terminal. The method comprises providing a set of satisfaction scores each from an exemplary media content item and at least one similarity dataset defining a similarity among a plurality of media content items, receiving at least one reference to a group of the plurality of media content items, using the at least one similarity dataset for rating at least one member of the group according to satisfaction scores of similar the exemplary media items, and presenting at least one viewing recommendation to at least one member of the group, the at least one member being selected according to the rating.

### RELATED APPLICATION

This application is co-filed with a patent application by the same inventors, entitled Methods And Systems For Managing Viewing At Client Terminals (Attorney Docket No. 46584), which the content thereof is incorporated by reference as if fully set forth herein.

### FIELD AND BACKGROUND OF THE INVENTION

The present invention, in some embodiments thereof, relates to a system and a method for enhancing the user experience of a device for displaying media content from multiple sources and, more particularly, but not exclusively, to a system and a method for enhancing the user experience of a device for displaying media content from multiple sources by generating and displaying viewing recommendations.

During the last decade a great number of viewing choices are available to consumers today through service providers, such as satellite (SAT) and cable service providers, that deliver digital and/or analog media content through direct broadcast satellite and cable receivers. The delivered media content includes television programming, video on demand (VOD) services, radio programming, Internet content, interactive content, and databases from other networks, including proprietary networks.

As hundreds, sometimes more than a thousand, of media channels and media content services are currently available for viewing through these service providers, consumers cannot effectively process their viewing choices in a reasonable time. Thus, consumers may watch television programming without knowing that an alternative choice, which would be preferred, is available on a different viewing channel and/or media content service. In addition, consumers may ignore television viewing or recording opportunities because they are unaware that programming of interest is available on a viewing channel.

During the last years several methods and systems for assisting a viewer in the selection of media content have been developed. For example, International Publication Number WO 01/99427 published on Dec. 27, 2008 describes a system in which information from multiple channels is provided to users, wherein multiple channels of programming content are received at a service headend connection of user viewing, information about a viewing interests of a user at a display device are received from a user, a recommendation about a channel of interest of the user is determined, based on the received information, and the user is informed of the recommended channel at the display device. A user may designate an interface agent that is associated with received user information for display on a viewing device.

Another example is described in US Patent Application Publication No. 2007/0055994 published on Mar. 8, 2007 that discloses a viewing recommendation apparatus includes an acquisition unit configured for acquiring first broadcast program information for each of first broadcast programs to be broadcasted, a storage unit configured to store a plurality of previously broadcasted second broadcast programs in correspondence with second broadcast program information, a calculation unit configured to calculate an urgency in accordance with the first broadcast program information and the second broadcast program information to obtain a plurality of urgencies, the urgency indicating a degree to view a broadcast program earlier, and a generation unit configured to generate a recommendation list of programs to be viewed based on levels of the urgencies.

### SUMMARY OF THE INVENTION

According tot some embodiments of the present invention there is provided a method for promoting one or more media contents according to viewing habits at a client terminal. The method comprises providing a set of satisfaction scores each from an exemplary media content item and at least one similarity dataset defining a similarity among a plurality of media content items, receiving at least one reference to a member of a group of the plurality of media content items, using the at least one similarity dataset for rating at least one member of the group according to satisfaction scores of similar the exemplary media items, and presenting at least one viewing recommendation to at least one member of the group, the at least one member being selected according to the rating.

Optionally, the rating is performed by weighting each the satisfaction score according to the similarity of respective the exemplary media content item and combining the weighted satisfaction score to calculate the rating.

Optionally, the at least one similarity dataset comprises a plurality of datasets each defining a similarity between one of the plurality of media content items and each other of the plurality of media content items.

Optionally, the providing comprises for each the exemplary media content item, allowing at least one user to determine the satisfaction score via the client terminal.

More optionally, the allowing is performed by displaying at least one question on the client terminal and analyzing respective at least one question.

More optionally, the at least one question are displayed in an interactive process.

Optionally, the providing comprises collecting the exemplary media content items monitoring a plurality of viewing selections of media content items associated with the client terminal.

Optionally, the group is selected according to at least one broadcasting schedule.

Optionally, the group is selected according to at least one media content database.

Optionally, each member of the group is associated with a time tag defining a broadcasting schedule, the presenting being performed according to respective the time tag.

Optionally, the method further comprises generating the at least one similarity dataset by, for each the media content item: providing a plurality of content media profiles each comprising at least one field describing a respective the media content item, evaluating similarity between respective fields of each two of the plurality of content media profiles, and aggregating the similarity evaluation to a similarity score.

More optionally, the at least one field comprises a member of a group consisting of: a genre, a title, a director, starring actors, possible languages, length, a review, and a textual description.

More optionally, the evaluating comprises creating a frequency vector for the at least one field and computing a Cosine transform between respective the frequency vectors.

Optionally, the presenting comprises generating the at least one viewing recommendation according to the similarity of the respective at least one member with at least one of the exemplary media content item.

According tot some embodiments of the present invention there is provided a method for promoting at least one media content. The method comprises creating a viewing profile by monitoring a plurality of viewing selections of media content items associated with a client terminal, monitoring a plurality of media content sources for identifying a plurality of media content items each being available for display on the client terminal, identifying a match between the viewing profile and a group of the plurality of media content items, and presenting at least one viewing recommendation for at least one member of the group on the client terminal, the at least one member being selected according to the match.

Optionally, the method further comprises rating the group according to the match before the presenting, the presenting being performed according to the rating.

Optionally, the monitoring comprises analyzing at least one broadcasting schedule.

Optionally, the method further comprises scoring at least some of the plurality of media content items with a service provider score, the at least one member being selected according to respective the service provider score.

Optionally, the method further comprises scoring at least some of the plurality of media content items according to at least one rule, the at least one member being selected according to respective the scoring.

Optionally, the method further comprises scoring at least some of the plurality of media content items according to at least one rule, the at least one member being selected according to respective the scoring.

More optionally, the at least one rule is selected from a group consisting of: a user experience rule, an operational rule, and a commercial rule.

More optionally, the method further comprises the viewing profile comprises a weighted timeline for a media content item having at least one predefined characteristic further comprises measuring current time, locating a weight by locating the measured time in a weighted timeline, and weighting each member of the group according having the at least one predefined characteristic with the weight. The at least one member is selected according to respective the weighting.

More optionally, the at least one predefined characteristic is selected from a group consisting of: an adult rating, a description, and a tag.

More optionally, the method further comprises intercepting at least one reaction to the at least one viewing recommendation and updating the viewing profile according to the at least on intercepted reaction.

Optionally, the monitoring includes recording a member selected from a group consisting of: zapping during the presentation of a selected media content media content item, a viewing command given during the presentation of a selected media content item, and stopping the presentation of a selected media content media content item before the completion thereof.

Optionally, the viewing profile comprises at least one exemplary media content item and a suitability score thereof to the client terminal, the identifying comprises selecting the group by estimating the similarity between at least one exemplary media content item and each the media content item.

Optionally, the at least one viewing recommendation comprises a member selected from a group consisting of: a visual promotion, an audio promotion, a trailer, a graphical representation, an image, a viewing reminder, a promoting text, a promoting audio segment, and a promoting graphic element.

Optionally, the media content item is selected from a group consisting of: a movie, a chapter of TV series, a TV series, a TV movie a VOD entry, an interactive game, a multiplayer game, gaming module, a TV show, an audio show, a concert, a sport event, and a news broadcast.

According to some embodiments of the present invention there is provided a system for promoting media content. The system comprises a media content profile repository for hosting a plurality of media content profiles each related to a media content item, a viewing profile module configured for acquiring a viewing profile associated with a client terminal defining at least one user preference, an availability module for identifying a group of the plurality of media content profiles, each member of the group being related to a media content item available for presentation during a common period frame, and a promotion unit configured providing at least one viewing recommendation to at least one member of the group, the at least one member matching the at least one user preference.

According to some embodiments of the present invention there is provided a system for promoting at least one media content. The system comprises an input unit configured for receiving a plurality of references to exemplary media content items each associated with a satisfaction score and a client terminal, a similarity repository for hosting at least one dataset defining a similarity among a plurality of media content items, a matching engine configured for selecting a group of media content items similar to exemplary media content items having a relativity high satisfaction score by using the at least one dataset, and a viewing recommendation module configured for providing at least one viewing recommendation to at least one member of the group.

Optionally, the viewing recommendation module is configured for generating the at least one viewing recommendation to a respective the at least one member according to the respective similarity.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a method for generating one or more viewing recommendations, according to some embodiments of the present invention;

FIG. 2 is a schematic illustration of a viewing recommendation system that is connected to a plurality of client terminals via a communication network, according to some embodiments of the present invention;

FIG. 3 is a flowchart of an exemplary process for preprocessing textual fields of media content items, according to some embodiments of the present invention.

FIG. 4A is a schematic illustration of a rule tree, according to some embodiments of the present invention;

FIG. 4B depicts exemplary operational rules, according to there fields, according to some embodiments of the present invention;

FIGS. 4C-4D depict exemplary user experience rules, according to there fields, according to some embodiments of the present invention;

FIG. 4E depicts exemplary commercial rules, according to there fields, according to some embodiments of the present invention;

FIG. 5 is a graphical user interface that displays a plurality of viewing recommendations, such as images and/or trailers, according to some embodiments of the present invention;

FIG. 6 is a flowchart of a method for generating viewing recommendations, according to some embodiments of the present invention;

FIG. 7 is a flowchart of a method for providing an initial viewing profile, according to some embodiments of the present invention;

FIG. 8 is a graph of a Gaussian distribution of the possibly rating of the media content “Miss Congeniality” in a predefined user prototype; and

FIG. 9 is schematic illustration of display an alert for the availability of a first media content item that appears during the displaying of a second media content item.

### DESCRIPTION OF SPECIFIC EMBODIMENTS OF THE INVENTION

The present invention, in some embodiments thereof, relates to a system and a method for enhancing the user experience of a device for displaying multiple media channels and, more particularly, but not exclusively, to a system and a method for enhancing the user experience of a device for displaying multiple media content from various sources by generating and displaying viewing recommendations.

According to an aspect of some embodiments of the present invention there are provided systems and methods for monitoring viewing habits at different client terminals, such as STBs and providing respective viewers with viewing recommendations to available media content, such as TV shows, movies, games and/or video on demand entries which is similar to other media content they tend to like. Optionally, the viewing recommendations are provided as trailers. Optionally, each client terminal is associated with a viewing profile which may be updated according to the viewing selections and/or viewing habits of one or more users. Optionally, the viewing recommendations may be changed and/or updated according to rules, such as business rules. Optionally, the viewing profile is dynamically changed, for example according to a certain timeline or one or more current viewers. In such a manner, the viewing profile reflects preferences which are related to the time of the day, a certain hour, a certain day, a certain week, and a combination thereof. Optionally, the viewing profile is adjusted according to the reactions of the viewers to the viewing recommendations. In such an embodiment, the viewing recommendations may be interactively adjusted according to the viewer selections. Optionally, the viewing recommendation system and/or method allow the viewer to configure the rules according to which viewing recommendations are selected and/or displayed.

According to an aspect of some embodiments of the present invention there are provided a method for promoting one or more media content items. The method is based on viewing profile that includes a list of a plurality of references to exemplary media content items. Each item of the list is associated with a satisfaction score, such as a score which has been given and/or estimated to the satisfaction of a certain viewer and/or a group of viewer that use the same client terminal, to the item. The method is also based on a number of datasets, such as matrixes, that define the similarity among a plurality of media content items, for example the similarity between the TV show “the love boat” and the movie “Rambo”. In the method, a group of plurality of media content items is received, for example from a module which is designed to identify which media content is currently available at a certain client terminal. Then, one or more of the members of the group is selected for promotion by using the aforementioned datasets. The similarity between each member of the group and the exemplary media content items is scored by there receptive satisfaction scores. Then, this similarity is used to determine which members may be recommended for viewing and optionally in which order and/or manner.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

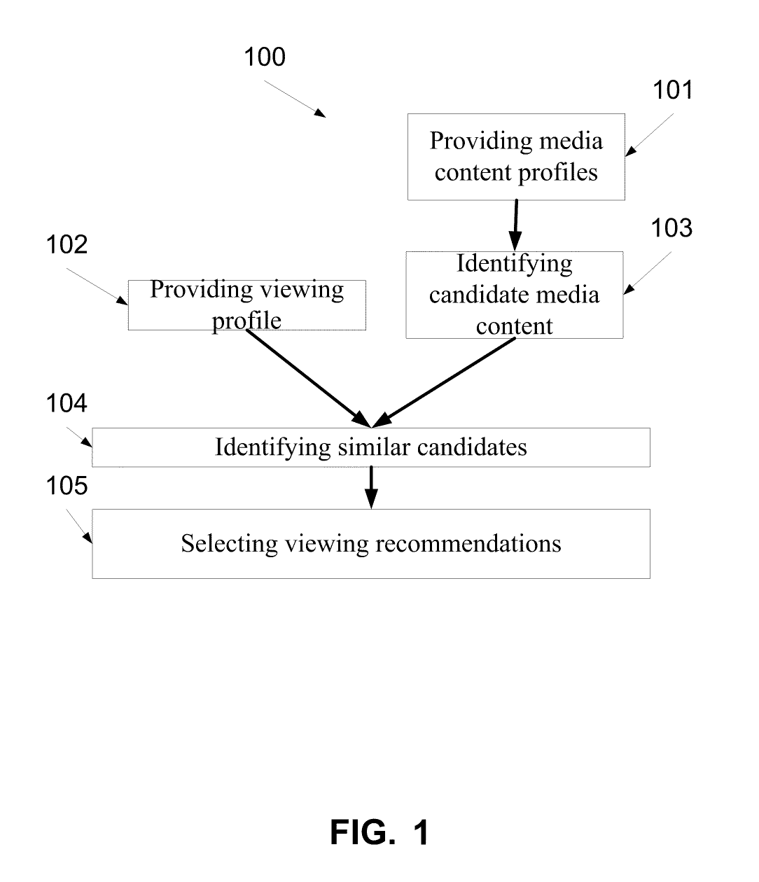

Reference is now made to FIG. 1, which is a schematic illustration of a method 100 for generating one or more viewing recommendations, according to some embodiments of the present invention. As used herein, a viewing recommendation means a visual promotion, an audio promotion, a trailer, a graphical representation, an image, a viewing reminder, a promoting text, a promoting audio segment, a promoting graphic element, a media content that is designed for encouraging a viewer to watch media content and any combination thereof. As used herein a promotion means conscious and/or subconscious promotions.

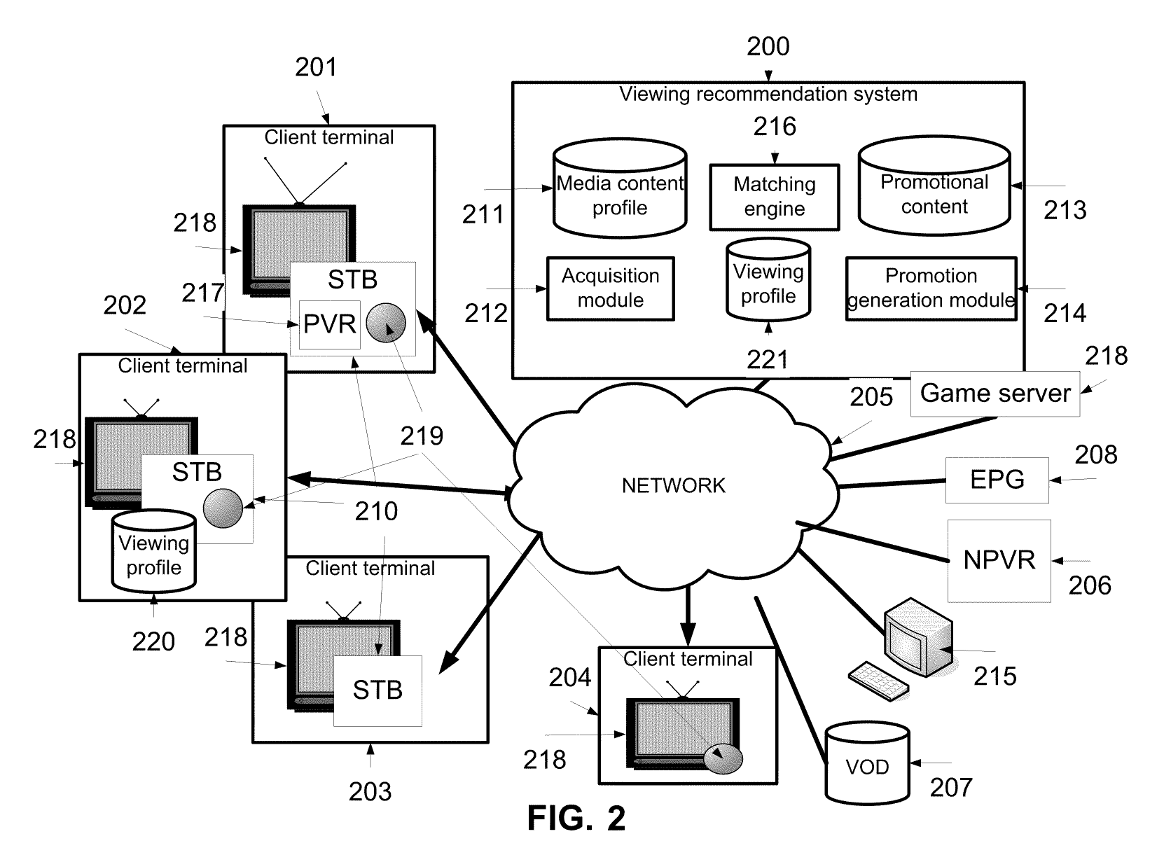

Reference is also made to FIG. 2, which is a schematic illustration of a viewing recommendation system 200 that is connected to a plurality of client terminals 201-204 via a communication network and/or infrastructure 205, according to some embodiments of the present invention. As used herein a client terminal means a cable STB, a satellite STB, a digital TV (DTV), a mobile phone, a web station, such as a personal computer, a laptop, a personal digital assistant (PDA), and/or any other device which is designed to intercepted a plurality of streams and/or transmissions of changeable media content, such as TV channels, and/or VOD entries. Optionally, the client terminal may include a display 218 for displaying media content items, for example as shown at 210. As used herein a media content item means a movie, a chapter of TV series, a TV series, a TV movie a VOD entry, an interactive game, a multiplayer game, gaming module, a TV show, an audio show, a concert, a sport event, a news broadcast, and/or any other discrete media content that can be displayed and/or played using a client terminal. The media item are available at via media content service, such as TV shows, movies, TV series, the Internet, a personal video recorder (PVR), a network PVR (NPVR) 206, and game servers. It should be noted that though only four client terminals 201-204 are depicted in FIG. 2, the viewing recommendation system 200 may be connected to any number of client terminals.

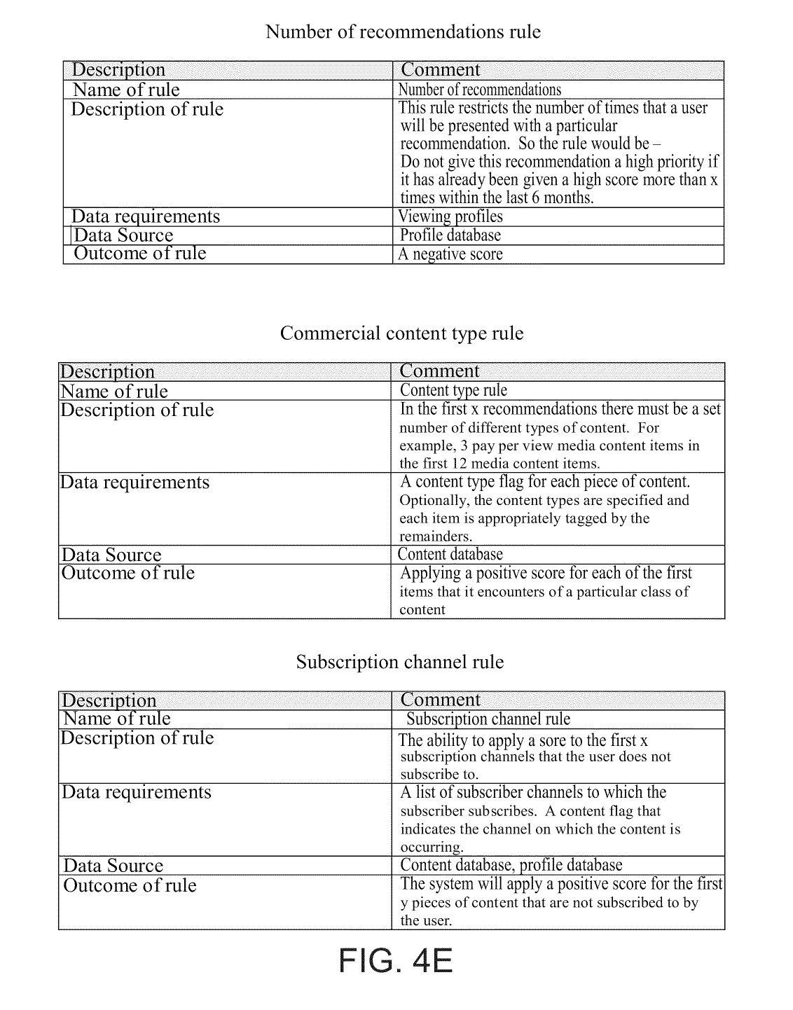

In some embodiments of the present invention, the method 100 and/or the system 200 are designed for providing one or more viewing recommendations to media content items which are available at a certain client terminal, such as a cable STB or a satellite STB 210. Optionally, as further described below, the viewing recommendations are designed to be presented on the client terminal as a set of trailers, for example as depicted in FIG. 5.

In some embodiments of the present invention, a profile managing module 219 is installed in each one of the client terminals 201, 202, and 204. The profile managing module 219 is optionally software and/or hardware add-on that supplements and/or enhances the original software and/or hardware of the client terminal in which it is installed. Optionally, the profile managing module 219 is used for monitoring viewing selections and/or viewing recommendation browsing which are performed on the respective client terminals, for example as further described below in relation to the iterative process of updating a viewing profile. It should be noted that the viewing profile may be locally stored on the client terminal, as shown at 220, and/or on central server, for example as shown at 221.

Optionally, the profile managing module 219 is used for connecting the client terminal to other components of the system, such as the matching engine 216 and/or the databases 211, 213 which are described below. Optionally, the profile managing module 219 is configured for generating a graphical user interface (GUI) and to display it on the respective display 218. The GUI may be used for displaying the viewing recommendations, for example as described above and/or depicted in FIG. 5. Optionally, the GUI is used for presenting a set of questions which may be used for rating media content items, for example as described below.

It should be noted that some or all of the functionalities which are provided by the profile managing module 219, as outlined above and described below, may be provided by a central server (not shown) that manages the viewing profiles of the different client terminals. In such an embodiment, as shown at 203, the client terminal may not have a profile managing module. The user's viewing selections are tracked selections are stored at the central server and made available to analysis modules for generating the viewing recommendations, optionally as described below.

As shown at 211, a media content profile database that includes a plurality of media content profiles is provided. As described above, the system and the method may be used for generating viewing recommendations to various channels and media content services which are displayed in a certain client terminal, such as shown at 201-204. In order to determine which viewing recommendations to generate, an automatic assessment of the suitability of various available media content items may have to be performed. Such an assessment may be based on an estimation of the similarity of the available media content items to media content items which have been rated and/or scored according to the satisfaction of one or more respective viewers thereto.

Optionally, each media content profile documents identifying information about a certain media content item that may be play and/or displayed. For brevity, displayed means any form of presenting media content, including but not limited to playing, displaying, and/or a combination thereof. The identifying information includes information that describes the related media content. For example, identifying information of a media content may include one or more of each one of the following a media content type tag, a title, a director, starring actors, possible languages, estimated and/or accurate length, one or more review fields, such as a review of a certain critic, and a description.

Optionally, the description of each media content profile comprises one or more of the following fields and/or associations:
Scripted entertainment fields—defines the related item, for example is the item is a TV Movie, a featured film, or a chapter of a dramatic television series, a television comedy, an animated television series, or a miniseries, a talk show, a reality television, and a game show. The fields may define a sub genre, such as a certain type of reality shows.
Informational fields—defines the related item, for example a news program, a documentary, and a television news magazine.
An event fields—defines the related item, for example a music concert or a sports events.

The media content profiles are optionally stored in a designated database, for example as shown at 211. The designated database 211, which may be referred to herein as a content profile database 211, may be updated every predefined period.

Optionally, the media content profile includes information advanced attributes such as media content mood, media content ending type, geographical location, estimated plot pace, and estimated plot complexity. The attributes may be manually inputted and or automatically acquired by an analysis of known attributes and/or an analysis of related content that is available in different sources online, such as a PVR 217 that is connected to the respective client terminal 210, an NPVR 206, and game server 218. For example, the system 200 is connected to one or more game servers. Optionally, the content profile database 211 comprises media content profiles of these video games. These games may have designated promotions, such as trailers and graphical elements, optionally as described below.

As programs and movies are expected to be broadcasted more than one time and as VOD items are available for long periods, some or all the acquired data is maintained in the content profile database 211 for future uses. Optionally, the media content profile may specify whether the media content item requires an additional payment and/or a certain subscription.

Optionally, the content profile database 211 comprises one or more media content profiles of other items which are available via the network, for example video streams which may be accessed via the internet 213, for example through www.youtube.com.

Optionally, the content profile database 211 comprises media content profiles of user recorded content, such as NPVR.

In some embodiments of the present invention, such media content profiles are used for evaluating, which may be referred to as estimating, the similarity between every two of the related media content items, optionally by analyzing the media content profiles 211. Optionally, the similarity is evaluated using a text similarity function that scores, for every pair of media content profiles, the textual similarity between respective fields. For example, for a pair of media content profiles i and j, the textual description field of the media content profile i is matched with the textual description field of the media content profile j.

For brevity, the similarity between i and j may be referred to herein as similarity(i,j). The similarity of an item i to the members of a set S may be calculated for every media content profile j. Optionally, similarity(i,j) is a weighted function in which every two field receive a different weight:

$$similarity ( i , j ) = {\sum }_{k = i}^{m} {α}_{k} * {sim}_{k} ( i , j )$$

where m denotes the number of fields, simₖ denotes the similarity between field k of media content profile i and field k of media content profile j, and aₖ denotes a weight taken from a vector of weights Aₘ. Optionally, the values of simₖ(X,Y) are normalized.

Different similarity functions may be used for different fields. For example, different similarity functions may be used for evaluating the similarity of non textual fields such as the year of release field, the duration of the related media content field, the adult rating field and/or any other rating field. A similarity function that evaluates the similarity between non-textual fields may be implemented using simple arithmetic. For example, the similarity in the field “year of release” may be a normalized value of the product of the absolute value of decreasing the value in one field from the value in another field.

The similarity of textual fields may use language processing, such as latent semantic analysis (LSA) for analyzing relationships between the terms and/or words they contain, see U.S. Pat. No. 4,839,853, filed on Sep. 15, 1988, which is incorporated herein by reference. Optionally, the similarity of respective textual fields is calculated by matching between the frequency vectors which have been calculated for each one of them.

Optionally, in order to reduce the computational complicity of the evaluation process the textual fields of the media content profiles are preprocessed. Optionally, text categorization (TC) is used for organizing the media content profile into categorizations by applying statistical methods or artificial intelligence techniques. In such a manner, the similarity between media content profiles is expected to be evaluated more efficiently. Optionally, for each media content profile, a word-frequency vector is calculated and stored during the preprocessing. In such an embodiment, the similarity between respective fields of evaluated media content profiles may be evaluated by computing the Cosine transform between the preprocessed frequency vectors.

It should be noted that functions may be provided for evaluating any textual and/or non textual field, such as the aforementioned description field, a professional reviews field, a user comments field, a TV guides text field, a box office statistics, a DVD rental statistics, usage data statistics and the like.

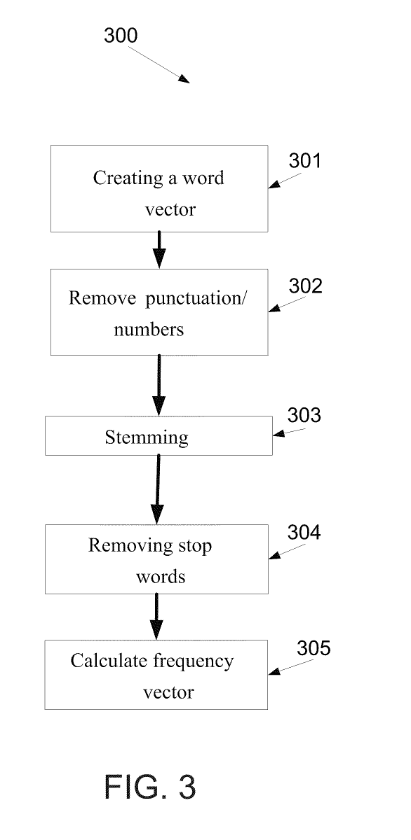

Reference is now also made to FIG. 3, which is a flowchart of an exemplary preprocessing 300 of textual fields of media content, according to some embodiments of the present invention. First, as shown at 301, a WordBank(i) vector is created for a media content profile textual field i. The WordBank(i) vector is created by parsing the original text of one or more of the fields of the media content profile. Optionally, as shown at 302, punctuation signs and/or number are removed. Then, as shown at 303 the WordBank(i) vector is stemmed. The words in the WordBank(i) are converted. In this block, the morphological root of each word in the WordBank(i) is determined in order to improve the evolution process and to reduce the computational complexity thereof. In the following block, 304, stop words are removed and/or tagged to be ignored. In such a manner, both space and time is saved. The WordBank(i) which have been stemmed and cleaned from stop words may be referred to herein as FinalWordBank(i). Now, as shown at 305, the word-frequency vector, which may be referred to herein as Freq(w, FinalWordBank(i)), is calculated.

The similarity between two respective frequency vectors may be evaluated by computing the Cosine between them. For example, the similarity between the media content profiles i and j is calculated as follows:

$$Cos ( Freq ( FinalWordBank ( i ) ) , Freq ( FinalWordBank ( j ) ) ) = {\sum }_{w ∈ FWB ( i ) ⋂ FWB ( j )} Freq ( w , FinalWordBank ( i ) ) * Freq ( w , FinalWordBank ( j ) ) / ( {\sum }_{w ∈ FWB ( i )} \sqrt{{Freq ( w , FWB ( i ) )}^{2}} * {\sum }_{w ∈ FWB ( j )} \sqrt{{Freq ( w , FWB ( j ) )}^{2}} )$$

where FWB is an abbreviation of FinalWordBank. Clearly, the output of Cos(i,j) is between 0 and 1. Optionally, the words in the frequency vectors are weighted according to their contextual and/or lingual importance. Optionally, a list of selected words, optionally weighted, is used. Optionally, the words that have high distinction power receive high weights and words that have low distinction power receive low weight. For example, descriptive words may receive a high weight while moderating words and general phrases receive a low weight.

In some embodiments of the present invention a similarity dataset, such as a similarity matrix, is calculated for each media content profile and optionally stored in association therewith. Optionally, the similarity datasets are updated whenever a new media content profile is added to the content profile database 211. In some embodiments of the present invention, the each media content profile hosts a similarity dataset and does not host the aforementioned identifying. In such an embodiment the similarity datasets are created by an independent system and/or apparatus and installed in the system 200 in advance. Optionally, the similarity datasets are updated periodically and/or upon request.

Such a repository of similarity datasets maps the similarities among various media content profiles of various media content items. It should be noted that the similarity may be represented in one or more multidimensional central datasets in order to improve the computational complexity and/or to reduce the storage requirements. As outlined above and described below, methods and systems of the present invention may be used for generating viewing recommendations which are suitable for a specific user and/or a client terminal. Optionally, the generated viewing recommendations are designed to media content items which are currently available to the specific user and/or client terminal to which they are provided. In order to provide such matching viewing recommendations, the media content profiles of the available media content items have to be analyzed.

Optionally, the content profile database 211 is connected to an availability module 212. The availability module 212 is designed to identify which media content items are currently available, optionally to each client terminal. Optionally, the availability module 212 acquires profile related data from various sources such as electronic program (me) guides (EPGs), websites, and the like. In particular, the identification may be performed by analyzing the current broadcasting schedule of the available channels, analyzing the media content which is available via media content databases such as VOD source, audio video on demand (AVOD) source, near video on demand (NVOD) source, Interactive TV source, datacasting, games source, internet protocol television (IPTV) over broadband networks, analyzing digital information from terrestrial digital broadcasting, direct broadcasting by satellite, cable broadcasting, Internet, and the like. For brevity, the identified media content items may be referred to herein as candidate media content items.

For example, the availability module 212 acquires EPG data, such as start times, program end times, program titles, program content, and the like periodically and/or upon request. Optionally, the availability module 211 acquires information every 24 hours, optionally for 24 hours.

Reference is now made, once again, to FIG. 1. As shown at 101, a plurality of media content profiles on a plurality of media content items is provided, for example as described above in relation to the creation of similarity datasets and/or profile database. As shown at 103, a group of candidate media content items is identified, for example received and/or tagged, for example as a group of references to media content items and/or media content profiles. Optionally, each media content profile is available for display on one of the client terminals in a common time frame. The media content profiles are optionally received from the availability module 212, as further described above.

As shown at 102, a viewing profile, which is associated with one of the client terminals, is provided in parallel, before, and/or after the media content profiles.

Optionally, the viewing profile 102 includes a plurality of exemplary media content items. Each one of the exemplary media content items is tagged with a satisfaction score that describes the satisfaction of one or more users related to the viewing profile 102 thereto. Optionally, the score is binary, for example 1 for like and 0 for dislike. Optionally, the score is between 0 and 1 where 1 stands for like and 0 stands for dislike. The satisfaction scores of certain media content items may be used for evaluating, using the aforementioned similarity datasets, the satisfaction of users related to the viewing profile to each one of the candidate media content items which have been selected in block 103. Optionally, the exemplary media content items are ordered according to their satisfaction scores.

It should be noted that the viewing profile may be a prototype profile which is optionally selected as described below.

In some embodiments of the present invention, the viewing profile includes exemplary media content items which have been selected according to the activation of the respective client terminal. Optionally, the viewing profile includes tenths, hundreds, thousands, hundreds of thousands, or millions of exemplary media content items. Optionally, each one of the exemplary media content items is associated with a time tag. Optionally, each one of the exemplary media content items is associated with a user ID that represents the user that made the respective viewing selection.

Optionally, the profile managing module 219 is designed to identify the user, either by analyzing the viewing selections and learning how to associate them to a certain user, for example according to their timing and/or similarity to other selections or by displaying GUI, for example when the user starts using the client terminal, who she is.

Optionally, the profile managing module 219 is designed to allow a user of the client terminal to define a viewing pattern, such as a daily, weekly, monthly, and/or yearly viewing pattern. Optionally, the user associate different users to different time frame, where each user has different characteristics and preferences. In such a manner, a parent may define the media sources and/or the type of viewing recommendations that may be displayed at the time frames which are associated with a child user.

Optionally, the profile managing module 219 is designed to update the viewing profile according to the viewing selections which are performed by the user. Optionally, the profile managing module 219 scores and/or adjusts the satisfaction score of a certain media content. The scoring and/or adjusting may be performed by presenting one or more questions via the client terminal and/or by analyzing the viewing and/or selection patterns of the user. For example, the profile managing module 219 may be designed to monitor whether media content item and/or a respective viewing recommendation have been fully watched, zapped, paused for long periods, declined, and the like. Optionally, the profile managing module 219 tracks viewing commands, such as rewind, forward, and pause, which are given during the presentation of the media content item. Optionally, the profile managing module 219 may be designed to score media content items according to whether a certain user followed a respective viewing recommendation, optionally as described below.

Now, as shown at 104, candidate media content items that match the viewing profile are found. In some embodiment of the present invention, the candidate media content items which are similar, substantially similar, or most similar to the exemplary media content items with which the user and/or the client terminal has the highest satisfaction, are found. As described above, each media content profile is associated with a similarity matrix. The similarity matrix includes values that define the similarity of each one of the other content profiles to the related media content item. Optionally, the media content profiles of the exemplary media content items are acquired from the content profile database 211. As described above, each one of the exemplary media content items is associated with a satisfaction score that reflects the satisfaction of the viewing profile to thereto.

Optionally, each one of the candidate media content items is rated according to the satisfaction scores of the exemplary media content items. The candidate media content items with the highest rate, which may be referred to herein as selected media content items, are optionally tagged for promotion. As further described below, the exemplary media content items may be part of a prototype profile that is associated with the user.

Optionally, the rating of a certain candidate media content item is determined using its similarity dataset, for example a similarity matrix that is associated with its media content profile. In such an embodiment, the satisfaction scores of the exemplary media content items are multiplied by, divided by, added with, and/or subtracted with the similarity values, which are taken from the respective similarity matrix to create an aggregated score that reflects a suitability level, and/or any derivative thereof. Such an aggregated score may be exemplified by using the following Pseudo code:

Set a rating list where all candidate media content item ratings=0

For each exemplary media content item
For each candidate media content item
   candidate media content item rating+=exemplary media content item satisfaction score*similarity value of respective candidate
media content item
Next exemplary media content item
Add media content item rating to the rating list

Next candidate media content item

Order the rating list according to candidate media content item ratings

Optionally, the system 200 comprises a matching engine module 216 for acquiring the records from the content profile database 211 and for performing the rating. Optionally, the matching engine module 216 is hosted on a server, such as web server, for example internet information server (IIS) or Apache server and connected via the Internet or a virtual private net to other nodes of the system.

Optionally, the selected media content items are the media content items with a rate that is above a predefined threshold.

In some embodiments of the present invention, the candidate media content items are selected and/or filtered by a set of one or more rules and/or dynamic and/or static constrains. Optionally, each one of the media content profiles is associated with one or more static and/or dynamic weights which are determined according to the content of the related media content items. In such an embodiment, the rating of each one of the candidate media content items is affected by the weights. Such a dynamic weight may be changed or factored according to the time of the day, the day of the week, the calendar, the season, and the like. For example an adult movie may be attached with a dynamic weight that depends on time of the day.

Optionally, a dynamic weight which is affected by the adult rating is associated with the media content items. In such an embodiment, movies with high adult rating may receive a low rating during the daytime, while children may watch, and high rating during the nighttime, while usually adults use the client terminal.

Optionally, a dynamic weight is affected by user selections. For example, the user may define a preferred length, a preferred length in selected time frames, a preferred genre in a preferred length in selected time frames and the like. The user may select, optionally using a toggle box and/or any other selection mechanism, a preferred length for the recommended media content items. In such an embodiment, the dynamic weight may increase when the length of the related media content item is similar to the preferred length and decrease when the length of the related media content item is dissimilar. In another example, the user may select a media content characteristic, such as genre, for example comedy, drama, reality show and/or action. In such an embodiment, the dynamic weight may increase when the characteristics of the related media content item are similar to the selected characteristics and decrease when the characteristics of the related media content item are dissimilar.

In some embodiments of the present invention, the media content items, which are promoted by the view recommendations, are selected according to a set of rules, optionally related business rules. Such rules allow the operator of the system to adjust the viewing recommendations according to the definitions of the content providers and/or other factors which are related and/or not related to the respective viewing profile.

In some embodiments of the present invention, the matching engine comprises a business rule module for implementing and/or creating the set of rules.

In use, the business rule module receive adjustment requests from the client terminals 201-204 and/or of from the matching engine 216. The adjustment request includes a request ID that indicates the respective viewing profile, a viewing profile ID that indicates how are the potential viewers to whom the rule applies, a time stamp of the request, a request type, and a category type.

Optionally, the set of rules includes one of more of the following rules:
1. Operational rules—rules that apply certain limitations on the viewing recommendations, which may be adjusted and/or selected according to the viewing profile and/or users which are associated with the viewing profile. For example, an age restriction rule that is selected according to the age of the user.
2. User experience rules—rules which are applied to assure that the viewing recommendation does not wear out the viewer. For example, rules which are based on previously presented viewing recommendations and applied to make sure that viewing recommendations are not repetitively presented.
3. Commercial rules—rules which are applied to promote one or more media contents. These rules are entered to meet specific business and/or commercial definitions.

Optionally, one or more of the set of the rules are applied to a viewing profile that have one/or more predefined characteristics. For example, rules are applied according to the one or more user IDs of a certain client terminal, which are associated with a predefined group and/or have predefined characteristics.

Optionally, the user may define one or more rules for her profile, optionally using a designated GUI on her client terminal.

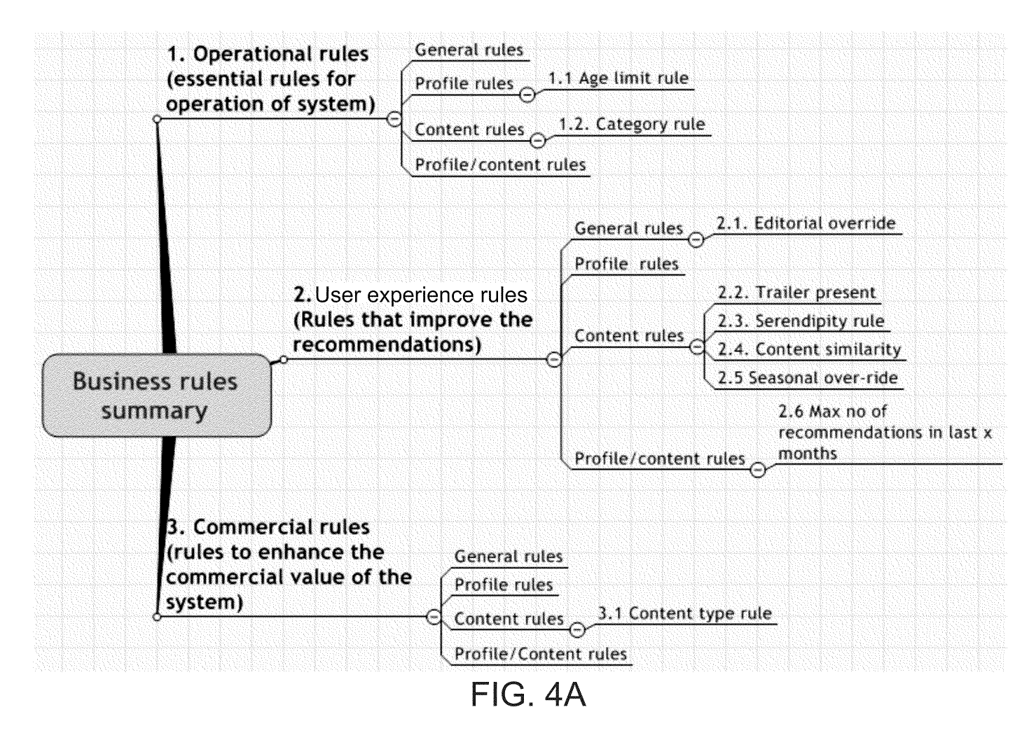

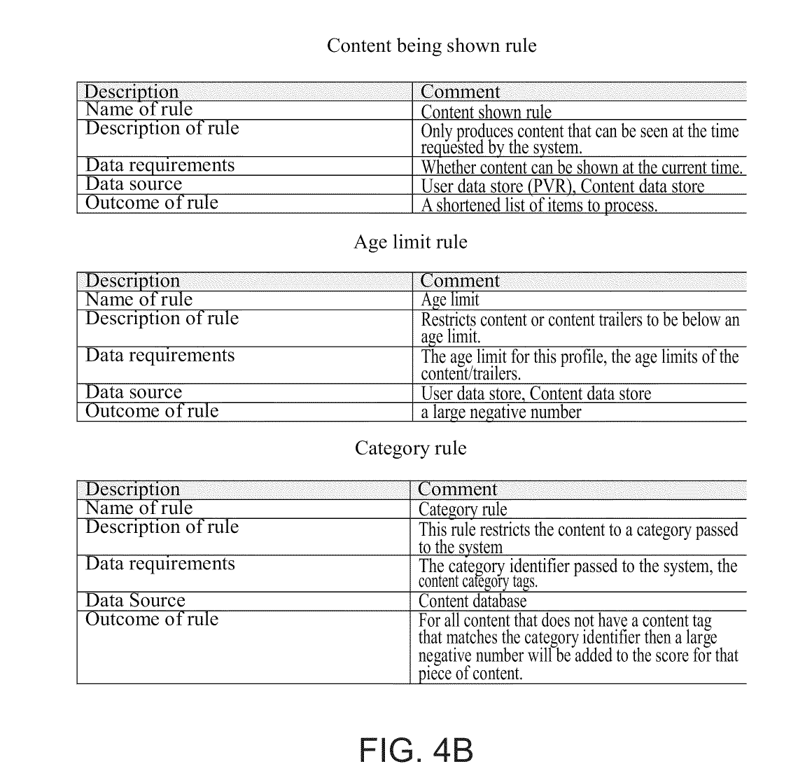

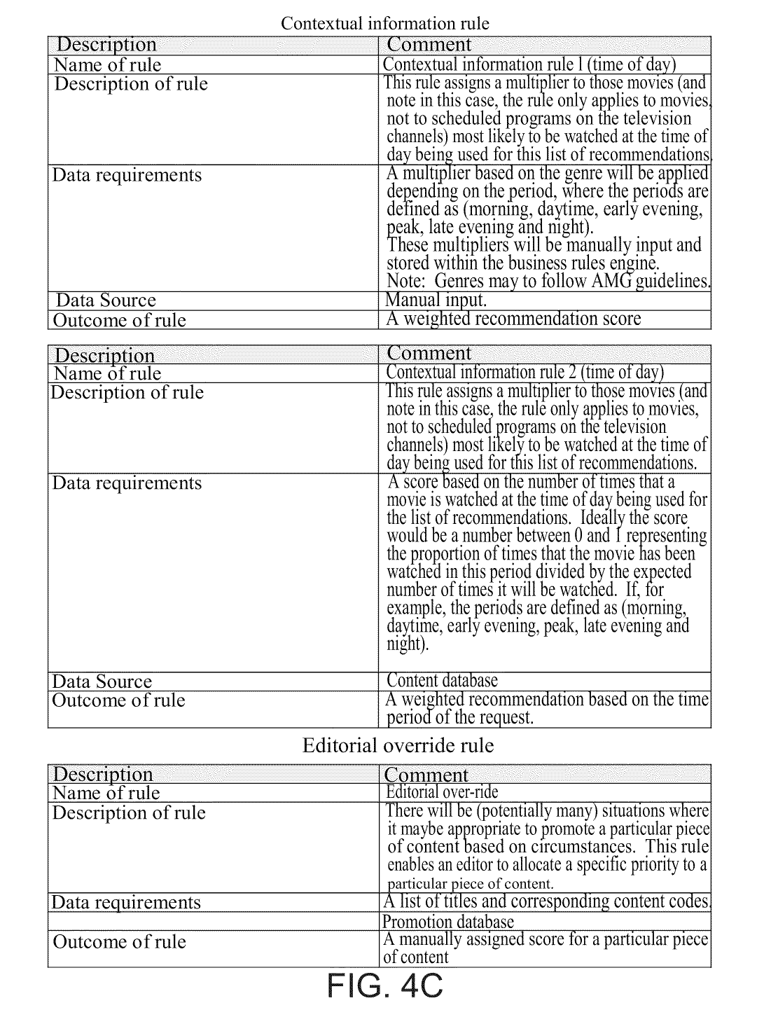

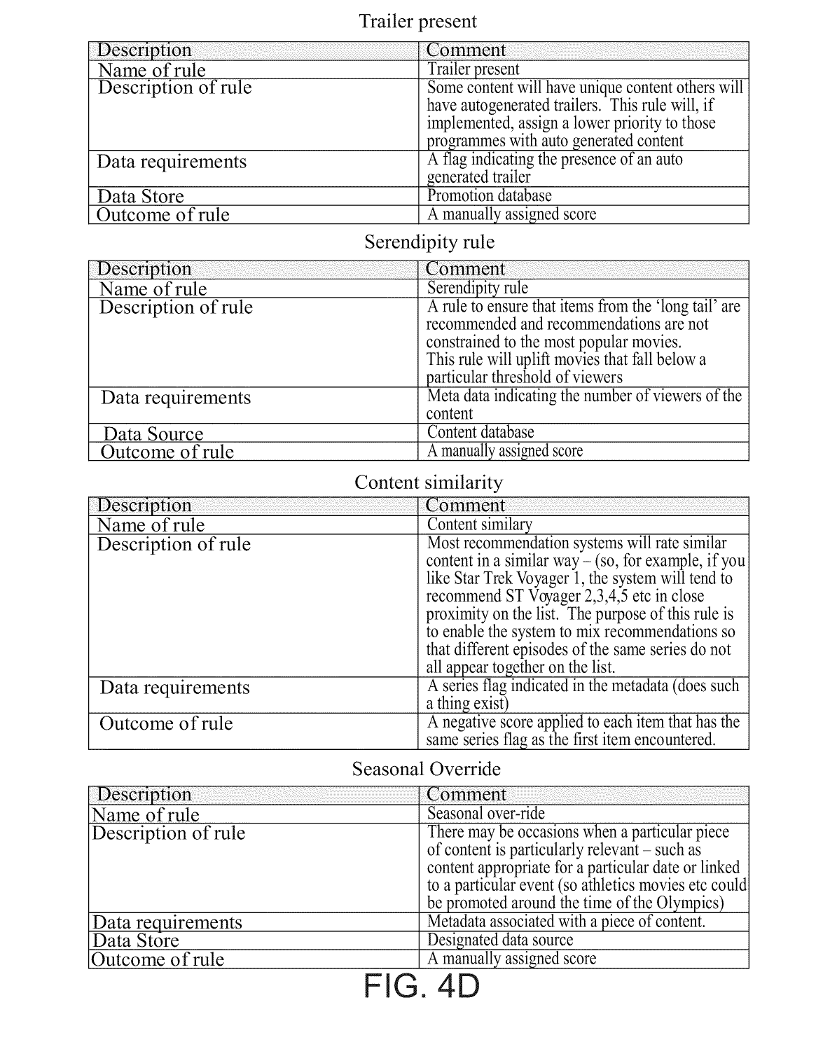

Optionally, the set of rules are arranged in a tree, for example as depicted in FIG. 4A, which is a schematic illustration of a rule tree, according to some embodiments of the present invention. As depicted in FIG. 4A, the set of rules are divided to groups, optionally as defined above, wherein each group has:
1. General rules which are not related to specific media content items.
2. Specific rules which are related to specific media contents.
3. Profile rules which are specific to a certain profile and/or to a characteristic, as described above.
4. Profile/content rules which are related to a combination of a profile and a media content item.

Optionally, the system operator may set the set of rules from the operator terminal 215.

The business rule module is designed for tagging each one of the selected media items. Optionally the tagging is binary, for example by using a true/false flag. Optionally, the tagging includes attaching a weighed value to the related media content.

Alternatively, a rule can set a priority level for a particular item of the selected media items and/or to add new media content to the selected media items, such as a content which is not selected according to the viewing profile however promoted by a certain content provider.

Optionally, a rule may be used to add media content items, to determine the place viewing recommendation in the presentation order, and/or to determine the manner the viewing recommendation is displayed.

Optionally, the viewer's GUI and/or the operator terminal 215 allow the viewer and/or the operator the select the rules, for example from a list of rules. Optionally, each rule is marked using the following fields: a rule ID, a description, one or more data input requirements, data sources, such as a VOD, a channel and the like, an outcome of the rule, and/or operator comments. FIG. 4B depicts exemplary operational rules, according to there fields. FIGS. 4C-4D depict exemplary user experience rules, according to there fields. FIG. 4E depicts exemplary commercial rules, according to there fields.

Now, as shown at 105, viewing recommendations to the selected, and optionally filtered, media content items are provided at the client terminal an optionally played and/or displayed to the user. Optionally, the system 200 is connected to a promotion repository 213 that hosts a plurality of promotion files, such as trailers. The repository holds all available trailers; each associated with the one or more media content items it represents. Optionally, the system 200 selects a viewing recommendation for each one of the selected media content items.

In some embodiments of the present invention, the viewing recommendations are trailers. Optionally, the trailers are presented sequentially, for example according their rate. Optionally, the trailers are presented simultaneously, for example in an arrangement that is determined according to their rate, for example as depicted in FIG. 5. Optionally, if a trailer does not exist in the promotion repository 213, an image, a text message, a dynamic template which is updated with the aforementioned identifying information, and/or a video segment that is recorded from the channel and/or the media source is displayed on the client device.

Optionally, the system 200 may be designed for managing automatic recording of recommended media content items for a certain subscriber. In such an embodiment the system may constantly or periodically evaluate the which media content items are rated above a predefined rating and automatically send a record commend to the PVR of the respective client terminal and/or to the NPVR that manages the respective subscriber recordings.

Optionally, each one of the promotion files in the promotion repository 213 is associated with one or more of the following fields: a type—the type of the file, for example a trailer, an audio trailer, a text message, a graphical elements; a title; a description; language; length; age limit of the trailer; and an promoted content ID and/or pointer.

Optionally, the promotion repository 213 is connected to a promotion generation module 214. As described above, the promotion repository 213 allows displaying a promotion, such as a trailer to a certain media content item, thereby to brief the viewer about the content which has been identified as matching for his taste and/or for promoting the selected media content items. In order to provide such a brief and/or promotion, the promotion repository 213 hosts a viewing recommendation per media content profile in the content profile database 211. Optionally, the promotion repository 213 is designed to automatically acquire promotions to media content from the Internet. For example, promotion generation module 214 may access databases of websites that host trailers, such as www.imdb.com, and/or designated websites of movies and/or TV series. Optionally, the promotion generation module 214 includes one or more format converters to adjust the promotion to display on the client terminal. The adjustment may include converting file format, size, resolution, and/or system standard, such as phase alternate line (PAL) to national television standards committee (NTSC) and vice versa. For example, a TV trailer may be converted to be used by mobile and a trailer file from a DVD may be converted to a MPEG-2 format which is supported by the system 200.

Optionally, the promotion generation module 214 is designed for generating promotions, such as trailers, for media content items. Such a promotion may be generated by combining available media files, such as text, video and/or audio files. For example, a promotion may be created by combining a still image and a descriptive speech that is generated using a text to speech (TTS) engine that generates audio file from a textual segment, such as a description which is acquired from a related website and/or an EPG. Optionally, the promotion generation module 214 is connected to a templates archive with a plurality of trailer templates. Each trailer template may include generic media files such as characterizing clips, music, narrative soundtrack, and/or textual titles.

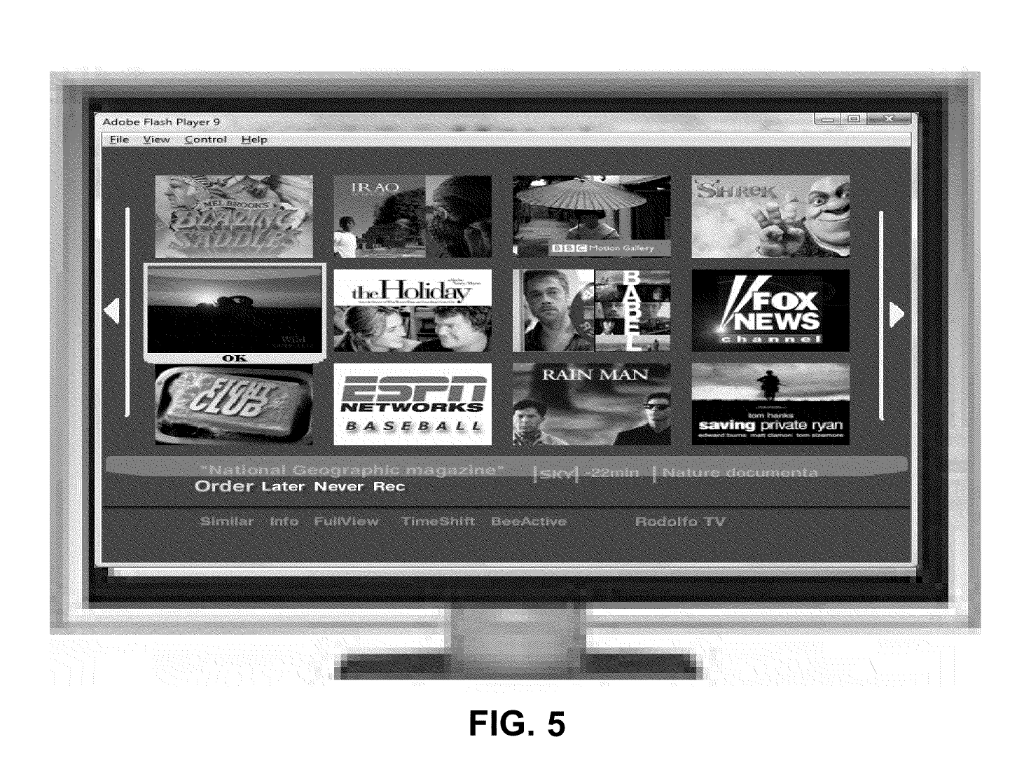

Reference is now also made to FIG. 6, which is a flowchart of a method for generating viewing recommendations, according to some embodiments of the present invention. Blocks 101-105 are as depicted in FIG. 1. FIG. 6 further depicts preprocessing blocks 401-402 and an iterative process for updating the viewing profile 403 and the media content profiles 404. The preprocessing of the media content profiles is described above in relation to the preparing of frequency vectors.

The iterative process, which is depicted in numeral 403, includes updating the exemplary media content items according to the user viewing selections. Optionally, the system is designed to rate the user viewing selections.

Optionally, the rating of viewing selections is performed manually. In such an embodiment, the system 200 is designed to present a rating question to the user after, before, and/or during the displaying of a media content item and/or a viewing recommendation, such as a trailer. Optionally, the rating question is binary, for example, allowing the observer to mark one of a number of toggle boxes which are presented in a proximity to descriptive words such as “like” and/or “dislike”. Optionally, the rating question allows the user to provide an accurate rating, for example, by allowing the observer to rate the media content item between 1 and 10.

Optionally, the rating of viewing selections is performed automatically. In such an embodiment, the system 200 is designed to track the observer's viewing selections. For example, if a media content item has been fully displayed, for example a chapter of a TV series which has been fully displayed and/or displayed without zapping, the received rating is high. On the other hand, if the media content item has not been sequentially displayed, the received rating is low.

Optionally, the system 200 is designed to track the observer's browsing during the viewing recommendations. In such an embodiment, not selecting a certain media content item may provide a low rating thereto. Optionally, as described above, the viewing recommendations are sequentially displayed. Optionally, the media content items which have recommended but not selected are ranked low. Optionally, the viewing recommendation is suggested with the following options: 1. “I like it! play”, 2. “not now, next”, and 3. “I do not like it, next”. In such an embodiment, the second choice may indicate that the user does not want to watch the recommended media content item from other reasons than relatively low satisfaction. For example, if a user marked the first choice for media content A, the second choice for media content B, and the third choice for media content C, A is rated with a low score, B is not rated or rated to reflect the apathy of the observer, and C is rated with a high score.

Optionally more complex algorithms for analyzing the viewing selections and/or viewing behavior of the observer may be employed for rating a certain media content item. Such algorithm may be based on the time a viewing recommendation was displayed, the scene during which the client switched a media content item. For example, if a user zapped and/or forwarded during a certain scene, such as a sex scene and/or violent scene, the system changes the aforementioned dynamic weight that is affected by the adult rating and/or any other respective weight. Such scenes may be identified using commonly known image processing algorithm which are well known in the art, and therefore not therefore will not be described in detail. Other algorithm for detecting viewing patterns, for example as a child user uses the client terminal at the afternoon time will an adult user uses the client terminal at the evenings may be used. This viewing pattern may affect the weight which is given to each candidate media content item, for example as described above.

The iterative process, which is depicted in numeral 404, includes updating the media content profiles according to changes in the media content that is suggested by the aforementioned sources, new EPGs, changes in the media content that is suggested by certain websites, and the like. The updating the may be performed periodically, according to the user request, according to the system operator request, and/or in response to a user selection.

In some embodiment of the present invention, the viewing profile may be generated in advance, optionally as shown at 402. As depicted in FIGS. 1 and 6, a viewing profile is needed in order to provide one or more viewing recommendations. Optionally, as described above, the viewing profile includes exemplary media content items. In order to adjust the viewing profile of a new client terminal and/or a new user before the viewing recommendation are generated, a preliminary setting process is needed.

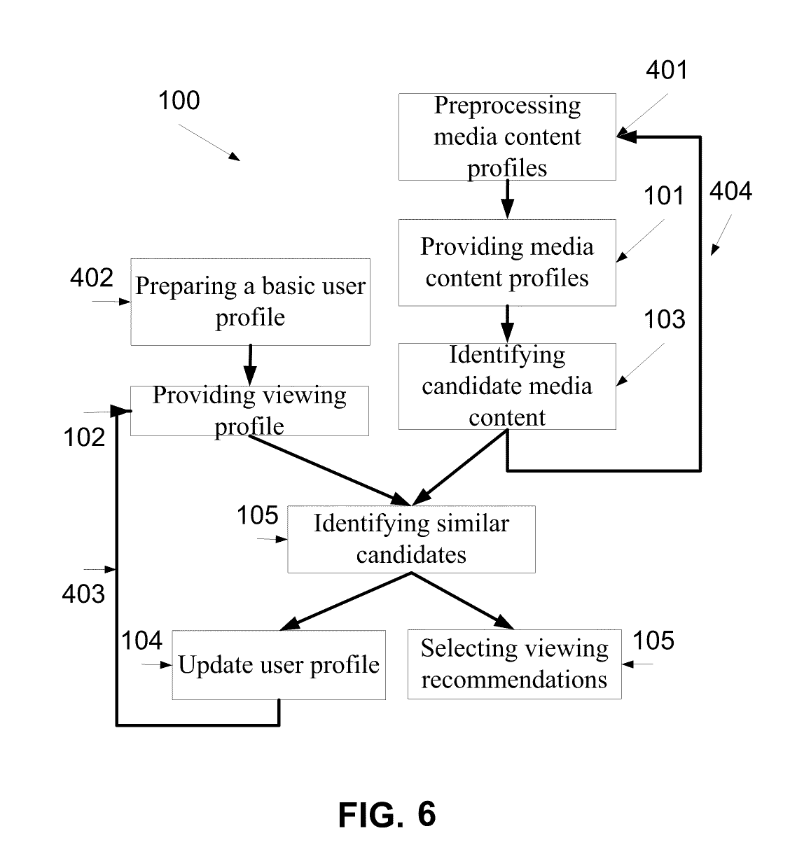

Reference is now also made to FIG. 7, which is a flowchart of a method 500 for providing an initial viewing profile, according to some embodiments of the present invention.

First, as shown at 501, a set of preliminary questions is displayed to the user. Optionally, the questions are provided by a GUI which is generated by the profile managing module 219. As shown at 502, the answers to these questions are collected. Optionally, the questions are used for estimating the user's satisfaction to a number of exemplary media content items. Optionally, the questions are presented as described above in relation to the iterative process that is depicted in numeral 403 of FIG. 6. In addition, as shown at 503, user prototypes are provided, optionally 12.

Now, as shown at 504, a match between the user and one of the user prototypes is found. Optionally, learning algorithm, such as an algorithm for calculating conditional probabilities, for example a Bayesian learning algorithm, is used for evaluating the probability that the related user belongs to one of the user prototypes. In such a manner, fewer questions may be used in order to obtain a good characterization of the user in terms of the available user prototypes.

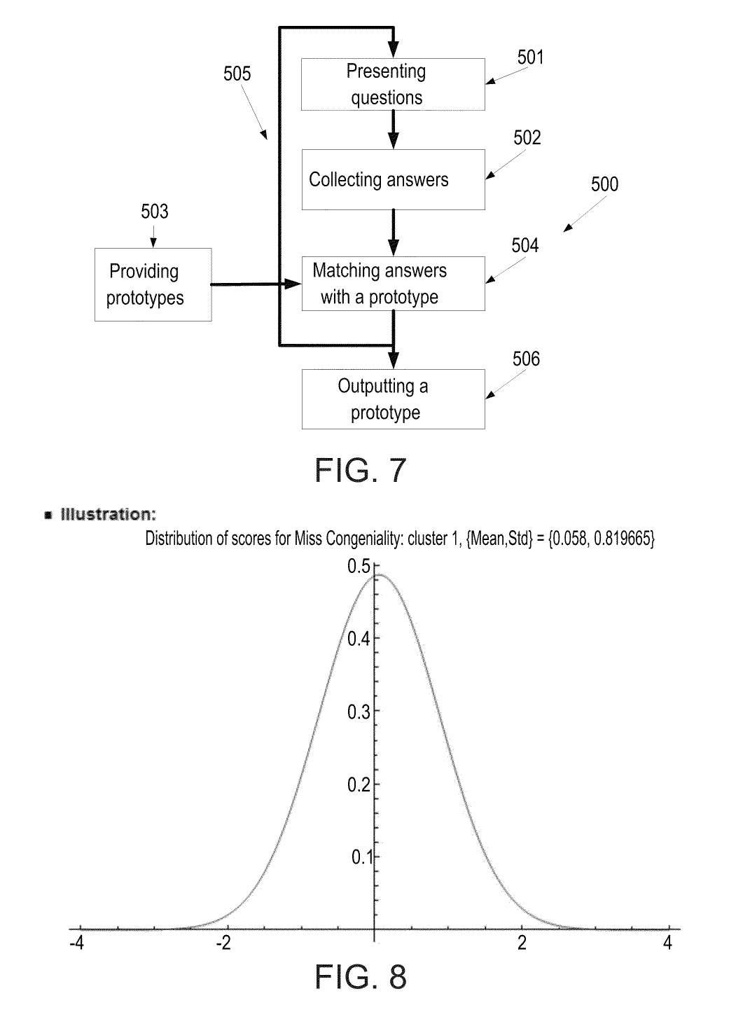

Optionally, each user prototype is derived from a statistical analysis of previously collected usage data, such as viewing selection and viewing habits. Optionally, a user prototype is defined by providing a probability distribution of rating to each exemplary content media item. The probability distribution describes the probability for each one of the possible ratings that a virtual user, which is characterized as suitable to the user prototype, may provide. Briefly stated, a Gaussian distribution with a certain mean and standard deviation is associated with each exemplary content media item. For example, FIG. 8 depicts a graph of a Gaussian distribution of the possibly rating of the media content “Miss Congeniality” where the mean is 0.058 and the standard deviation is 0.819665. The x-axis of the graph represents the possible ratings and the y-axis of the graph represents units chosen in such a way that the total area under the curve is equal to 1.

In some embodiments of the present invention, the set of question is dynamically changed, during the questioning process 501-502.

Optionally, the possible questions are arranged as a binary tree. In such a manner, each question may cut the number of possibilities by half. The actual number of questions to be asked is therefore the logarithm (in base 2) of the number of clusters, while the number of possible questions is equal to the number of clusters.

It should be noted that in order to reduce that change that questioned user is not familiar with one or more of the topics of the questions, for example with the media content item that she is being asked to rate, few substitutionary questions are provided.

The possible questions are selected with a discriminatory power that allows dividing the possibilities. For example, each question in the tree of question is selected in a manner that half of the user prototypes dislike the questioned media content and half of the user prototypes like the questioned media content.

As described above, the selected user prototype can now be outputted, as shown at 506, and used for generating viewing recommendations, optionally as further described above.

As described above, the system 200 is designed to generate viewing recommendations to a plurality of client terminals. Such viewing recommendations may be presented whenever client terminal is turned on, in predefined time intervals, in a fixed hour, and/or in response a user demand.

In some embodiments of the present invention, the generated viewing recommendations are provided on a certain client terminal whenever a certain media content item that is displayed the client terminal has come to an end.

It should be noted that the system 200 may be used a reminder system that is based on one or more broadcasting schedules. In such an embodiment, reminders to candidate media content items are sent according to the one or more broadcasting schedules and/or an output of the aforementioned availability module.

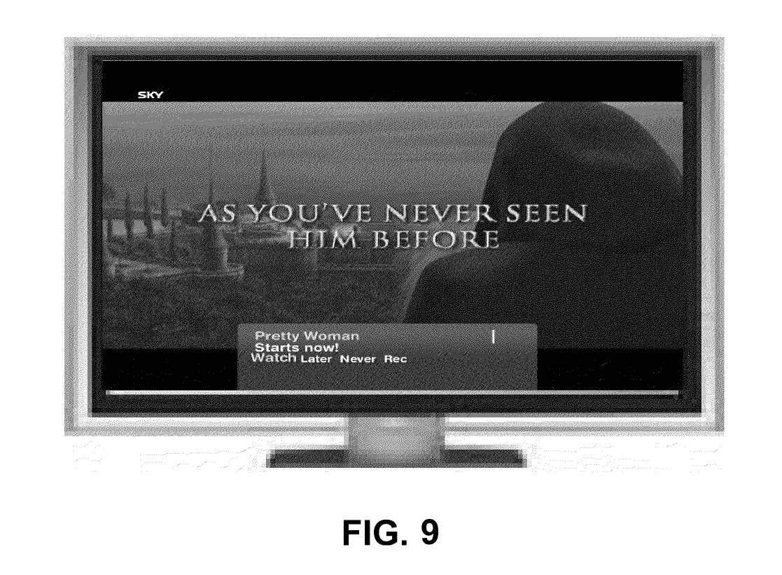

Optionally, the viewing recommendations are displayed automatically if the rating of a media content item is above a predefined level. In such am manner, the system may be used an alerting system to alert the users of a certain client terminal about the availability of a certain media content item. For example, the viewing recommendations may be generated every half an hour for the candidate media content items. In such an embodiment, even if the user is watching another media content item the viewing recommendation are presented on the screen are reminders. For example, FIG. 9 depicts an alert 550 for the availability of a first media content item that appears during the displaying of a second media content item.

In some embodiments of the present invention, the system 200 is connected to an operator terminal 215. Optionally, the operator terminal 215 allows an operator to edit the records which are stored in the content profile database 211, the promotion database 213. As used herein, such editing means updating, deleting, associating, reassociating, and/or changing the records which are stored in the databases 211, 213.

Optionally, the system 200 is connected to an advertisements repository that hosts a plurality of advertisements (ads), such as short commercial clips, graphical elements, text segments, audio segments, banner and/or any other promotional content for products and/or services. As further described below, these ads may be shown in between the rest of the broadcasted content. These clips may reside in a different server, database ands/or file system.

It is expected that during the life of a patent maturing from this application many relevant systems and methods will be developed and the scope of the term media content, managing engine, network, media content item, media content profile, and media source are intended to include all such new technologies a priori.

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, an and the include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for promoting at least one media content according to viewing habits at a client terminal, comprising:
providing a set of satisfaction scores each from an exemplary media content item and at least one similarity dataset defining a similarity among a plurality of media content items;
receiving at least one reference to a member of a group of said plurality of media content items;
using said at least one similarity dataset for rating at least one member of said group according to satisfaction scores of similar said exemplary media items; and
presenting at least one viewing recommendation to at least one member of said group, said at least one member being selected according to said rating.

2. The method of claim 1, wherein said rating is performed by weighting each said satisfaction score according to the similarity of respective said exemplary media content item and combining said weighted satisfaction score to calculate said rating.

3. The method of claim 1, wherein said at least one similarity dataset comprises a plurality of datasets each defining a similarity between one of said plurality of media content items and each other of said plurality of media content items.

4. The method of claim 1, wherein said providing comprises for each said exemplary media content item, allowing at least one user to determine said satisfaction score via the client terminal.

5. The method of claim 4, wherein said allowing is performed by displaying at least one question on the client terminal and analyzing respective at least one question.

6. The method of claim 5, wherein said at least one question are displayed in an interactive process.

7. The method of claim 1, wherein said providing comprises collecting said exemplary media content items monitoring a plurality of viewing selections of media content items associated with the client terminal.

8. The method of claim 1, wherein said group is selected according to at least one broadcasting schedule.

9. The method of claim 1, wherein said group is selected according to at least one media content database.

10. The method of claim 1, wherein each member of said group is associated with a time tag defining a broadcasting schedule, said presenting being performed according to respective said time tag.

11. The method of claim 1, further comprising generating said at least one similarity dataset by, for each said media content item:
providing a plurality of content media profiles each comprising at least one field describing a respective said media content item;
evaluating similarity between respective fields of each two of said plurality of content media profiles; and
aggregating said similarity evaluation to a similarity score.

12. The method of claim 11, wherein said at least one field comprises a member of a group consisting of: a genre, a title, a director, starring actors, possible languages, length, a review, and a textual description.

13. The method of claim 11, wherein said evaluating comprises creating a frequency vector for said at least one field and computing a Cosine transform between respective said frequency vectors.

14. The method of claim 1, wherein said presenting comprises generating said at least one viewing recommendation according to the similarity of said respective at least one member with at least one of said exemplary media content item.

15. A method for promoting at least one media content, comprising:
creating a viewing profile by monitoring a plurality of viewing selections of media content items associated with a client terminal;
monitoring a plurality of media content sources for identifying a plurality of media content items each being available for display on said client terminal;
identifying a match between said viewing profile and a group of said plurality of media content items; and
presenting at least one viewing recommendation for at least one member of said group on said client terminal, said at least one member being selected according to said match.

16. The method of claim 15, further comprising rating said group according to said match before said presenting, said presenting being performed according to said rating.

17. The method of claim 15, wherein said monitoring comprises analyzing at least one broadcasting schedule.

18. The method of claim 15, further comprises scoring at least some of said plurality of media content items with a service provider score, said at least one member being selected according to respective said service provider score.

19. The method of claim 15, further comprises scoring at least some of said plurality of media content items according to at least one rule, said at least one member being selected according to respective said scoring.

20. The method of claim 15, further comprises scoring at least some of said plurality of media content items according to at least one rule, said at least one member being selected according to respective said scoring.

21. The method of claim 20, wherein said at least one rule is selected from a group consisting of: a user experience rule, an operational rule, and a commercial rule.

22. The method of claim 15, said viewing profile comprises a weighted timeline for a media content item having at least one predefined characteristic further comprises:
measuring current time;
locating a weight by locating said measured time in a weighted timeline; and
weighting each member of said group according having said at least one predefined characteristic with said weight;
wherein said at least one member is selected according to respective said weighting.

23. The method of claim 22, wherein said at least one predefined characteristic is selected from a group consisting of: an adult rating, a description, and a tag.

24. The method of claim 15, further comprising:
intercepting at least one reaction to said at least one viewing recommendation; and
updating said viewing profile according to said at least on intercepted reaction.

25. The method of claim 15, wherein said monitoring includes recording a member selected from a group consisting of: zapping during the presentation of a selected media content media content item, a viewing command given during the presentation of a selected media content item, and stopping the presentation of a selected media content media content item before the completion thereof.

26. The method of claim 15, wherein said viewing profile comprises at least one exemplary media content item and a suitability score thereof to said client terminal, said identifying comprises selecting said group by estimating the similarity between at least one exemplary media content item and each said media content item.

27. The method of claim 15, wherein said at least one viewing recommendation comprises a member selected from a group consisting of: a visual promotion, an audio promotion, a trailer, a graphical representation, an image, a viewing reminder, a promoting text, a promoting audio segment, and a promoting graphic element.

28. The method of claim 15, wherein said media content item is selected from a group consisting of: a movie, a chapter of TV series, a TV series, a TV movie a VOD entry, an interactive game, a multiplayer game, gaming module, a TV show, an audio show, a concert, a sport event, and a news broadcast.

29. A system for promoting media content, comprising:
a media content profile repository for hosting a plurality of media content profiles each related to a media content item;
a viewing profile module configured for acquiring a viewing profile associated with a client terminal defining at least one user preference;
an availability module for identifying a group of said plurality of media content profiles, each member of said group being related to a media content item available for presentation during a common period frame; and
a promotion unit configured providing at least one viewing recommendation to at least one member of said group, said at least one member matching said at least one user preference.

30. A system for promoting at least one media content, comprising:
an input unit configured for receiving a plurality of references to exemplary media content items each associated with a satisfaction score and a client terminal;
a similarity repository for hosting at least one dataset defining a similarity among a plurality of media content items;
a matching engine configured for selecting a group of media content items similar to exemplary media content items having a relativity high satisfaction score by using said at least one dataset; and
a viewing recommendation module configured for providing at least one viewing recommendation to at least one member of said group.

31. The system of claim 30, wherein said viewing recommendation module is configured for generating said at least one viewing recommendation to a respective said at least one member according to said respective similarity.
